(19) United States
(12) Patent Application Publication
(10) Pub. No.: US 2021/0122945 A1
(43) Pub. Date: Apr. 29, 2021

(54) TAPE STRIP STACK

(71) Applicant: 3M INNOVATIVE PROPERTIES COMPANY, SAINT PAUL, MN (US)

(72) Inventors: AUDREY A. SHERMAN, WOODBURY, MN (US); ALEX S. PLASENCIA, SHOREVIEW, MN (US); KUMARS SAKIZADEH, WOODBURY, MN (US)

(73) Assignee: 3M INNOVATIVE PROPERTIES COMPANY, SAINT PAUL, MN (US)

(21) Appl. No.: 17/067,835

(22) Filed: Oct. 12, 2020

Related U.S. Application Data
(60) Provisional application No. 62/926,680, filed on Oct. 28, 2019.

(51) Int. Cl. C09J 7/38; B65H 1/04

(52) U.S. Cl. CPC C09J 7/38; B65H 1/04; B65H 2701/18262; C09J 2301/122; C09J 2301/302

(57) ABSTRACT

The disclosed tape strip stack is a stack of tape strips arranged one on top of the other for individual removal of each successive tape strip. Secured to a portion of an adhesive on the tape strip, and on alternating ends between successive tape strips, is a tab. The tab protects the adhesive at an exposed tape strip. In some cases, the tab is a removable release tab. Prior to use, the removable release tab is removed, such that a tape strip with an adhesive surface is available for use.

### CROSS-REFERENCE TO RELATED APPLICATION

This application claims the benefit of priority to U.S. Provisional Application No. 62/926,680, filed on Oct. 28, 2019, which is incorporated herein by reference in its entirety.

### TECHNICAL FIELD

The present disclosure relates to a tape strip stack.

### BACKGROUND

Adhesive tape is commonly used for many applications. Typically, an elongated tape is wrapped around a core into a roll. To use the tape, the elongated tape is pulled from the roll and cut or torn for a usable section, which typically requires two hands. Precut tape strips can be used. Precut tape strips in various shapes can be secured to a release liner and then peeled from the release liner for use. These precut tape strips on liners are not quickly dispensed for use. Individual sheets of precut tape strips on liners are also not easily organized. Stacks of tape strips that dispense as individual strips are commercially available as 3M Scotch Pop-up Tape, available from 3M Company. Stacks of tape strips are described in U.S. Pat. No. 5,086,946. These tape strip stacks have an exposed adhesive surface. For applications requiring a clean tape strip, such as in the medical field, the exposed adhesive surface on the tape strip stack can attract contaminants.

### SUMMARY

The disclosed tape strip stack is a stack of tape strips arranged one on top of the other for individual removal of each successive tape strip. Secured to a portion of an adhesive on the tape strip, and on alternating ends between successive tape strips, is a tab. The tab protects the adhesive at an exposed tape strip. In some cases, the tab is a removable release tab. Prior to use, the removable release tab is removed, such that a tape strip with an adhesive surface is available for use.

In one embodiment, a tape strip stack with a first end and a second end, opposite the first end, includes a first tape strip and a second tape strip. The first tape strip includes a substrate having a first major surface and a second major surface, opposite the first major surface; a low adhesion backsize at the first major surface of the substrate of the first tape strip; an adhesive disposed on an entirety of the second major surface of the substrate of the first tape strip; and a tab secured to a portion of the adhesive disposed on the substrate of the first tape strip at the first end of the stack. The second tape strip includes a substrate having a first major surface and a second major surface, opposite the first major surface; a low adhesion backsize at the first major surface of the substrate of the second tape strip; an adhesive disposed on an entirety of the second major surface of the substrate of the second tape strip; and a tab secured to a portion of the adhesive disposed on the substrate of the second tape strip at the second end of the stack. The adhesive of the first tape strip removably secures to the low adhesion backsize on the first major surface of the substrate of the second tape strip at the second end of the stack.

In one embodiment, the tape strip stack further includes a third tape strip. The third tape strip includes a substrate having a first major surface and a second major surface, opposite the first major surface; a low adhesion backsize at the first major surface of the substrate of the third tape strip; an adhesive disposed on an entirety of the second major surface of the substrate of the third tape strip; and a tab secured to a portion of the adhesive disposed on the substrate of the third tape strip at the first end of the stack. The adhesive of the second tape strip removably secures to the low adhesion backsize on the first major surface of the substrate of the third tape strip at the first end of the stack.

In one embodiment, the tab of each of the first, second and third tape strips is a removable release tab removably secured to the corresponding adhesive.

In one embodiment, the tab of each of the first, second and third tape strips is fixedly secured to the corresponding substrate.

In one embodiment, the tab of each the first, second and third tape strips is not secured to the first major surface of an underlying substrate.

In one embodiment, the adhesive of each of the first, second and third tape strips is fully coated on the entirety of the second major surface of the corresponding substrate.

In one embodiment, the adhesive of each of the first, second and third tape strips is pattern coated on the entirety of the second major surface of the corresponding substrate.

In one embodiment, the low adhesion backsize of each of the first, second and third tape strips is disposed on an entirety of the first major surface of the corresponding substrate.

In one embodiment, the adhesive of each of the first, second and third tape strips is a pressure sensitive adhesive.

In one embodiment, a dispenser includes an opening. The dispenser receives the tape strip stack. A portion of the substrate protruding through the opening is fully covered by the corresponding tab.

In one embodiment, a dispensing system includes a dispenser and a tape strip stack. The dispenser includes an opening. The tape strip is received within the dispenser. The tape strip stack with a first end and a second end, opposite the first end, includes a first tape strip and a second tape strip. The first tape strip includes a substrate having a first major surface and a second major surface, opposite the first major surface; a low adhesion backsize at the first major surface of the substrate of the first tape strip; an adhesive disposed on an entirety of the second major surface of the substrate of the first tape strip; and a tab secured to a portion of the adhesive disposed on the substrate of the first tape strip at the first end of the stack. A portion of the substrate of the first tape strip protrudes through the opening of the dispenser. The second tape strip includes a substrate having a first major surface and a second major surface, opposite the first major surface; a low adhesion backsize at the first major surface of the substrate of the second tape strip; an adhesive disposed on an entirety of the second major surface of the substrate of the second tape strip; and a tab secured to a portion of the adhesive disposed on the substrate of the second tape strip at the second end of the stack. The adhesive of the first tape strip removably secures to the low adhesion backsize on the first major surface of the substrate of the second tape strip at the second end of the stack. The portion of the substrate of the first tape strip protruding through the opening is fully covered by the tab of the first tape strip.

In one embodiment, a method of dispensing the tape strip stack of the dispensing system includes providing the tape strip stack in the dispenser. The method further includes extending the portion of the substrate of the first tape strip fully covered by the tab through the opening of the dispenser. The method further includes pulling the first tape strip to at least partially extend the second tape strip through the opening. The method further includes detaching the substrate of the first tape strip from the substrate of the second tape strip.

### BRIEF DESCRIPTION OF DRAWINGS

FIG. 1 is a side sectional view of one embodiment of a stack of tape strips;

FIG. 2 is a perspective view of one of the tape strips from the stack of FIG. 1;

FIG. 3 is a bottom view of the tape strip of FIG. 2 without a tab;

FIG. 4 is a top view of the tape strip of FIG. 2;

FIG. 5 is a side sectional view of one embodiment of a dispensing system including a dispenser and the stack of FIG. 1;

FIG. 6 is a flowchart of a method of dispensing the tape strips of the stack of FIG. 1; and

FIGS. 7 and 8 illustrate dispensing of one of the tape strips from the dispenser of FIG. 5.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

A conventional adhesive tape is generally wrapped around a core into a roll. To use the adhesive tape, an elongated tape is pulled from the roll and cut or torn for a usable section, which typically requires two hands. Such a roll of tape may have to be manually cut by a cutting member. It is difficult for a user to manually cut precise, uniform lengths of the adhesive tape from the roll as it is difficult to repeatedly measure the lengths precisely. Such a tape/dispenser combination is not suitable for situations which require quick and efficient dispensing of precise and uniform precut lengths of adhesive coated tape. Further, a form factor offered by a roll of tape on a core may create problems for the end users in a handheld setting. A roll of tape may be difficult to package, ship and fit into kits.

Precut tape strips can be used. Precut tape strips in various shapes can be secured to a release liner and then peeled from the release liner for use. However, individual sheets of precut tape strips on liners are not easily organized or quickly dispensed for use.

Stacks of tape strips that dispense as individual strips are commercially available. Conventional tape strip stacks have an exposed adhesive surface. For applications requiring a clean tape strip, such as in the medical field, the exposed adhesive surface on the tape strip stack can attract contaminants.

The tape strip stack of the present disclosure is a stack of tape strips arranged one on top of the other for individual removal of each successive tape strip. Secured to a portion of the adhesive on the tape strip, and on alternating ends between successive tape strips, is a tab. The tab protects the adhesive at the exposed tape strip. In some cases, the tab is a removable release tab. Prior to use, the removable release tab is removed, such that a tape strip with an adhesive surface is available for use.

The present disclosure also relates to a dispensing system including a dispenser and the tape strip stack. The dispenser includes a cavity for receiving the stack and an opening for sequential dispensing of the tape strips. An exposed portion of an uppermost tape strip extends through the opening, thereby enabling one-handed dispensing. The adhesive disposed on the exposed portion is fully covered by the tab. The adhesive may therefore be protected from contaminants.

The stack and the dispensing system of the present disclosure may enable one-handed dispensing. The stack may further enable compact and flat packaging as opposed to conventional tape rolls. Compact packaging may facilitate shipping and supply. The stack and the dispensing system can easily fit into kits. Further, the dispensing system can be easily placed at a point of use or care. The stack may also allow the tape strips to be organized efficiently.

As utilized herein, including the claims, the term “disposed on an entirety” describes a coating or a layer that is fully/flood coated on an entire surface or pattern coated (e.g., stripes, dots etc.) on the entire surface.

As utilized herein, including the claims, the term “stack” refers to a tape strip stack.

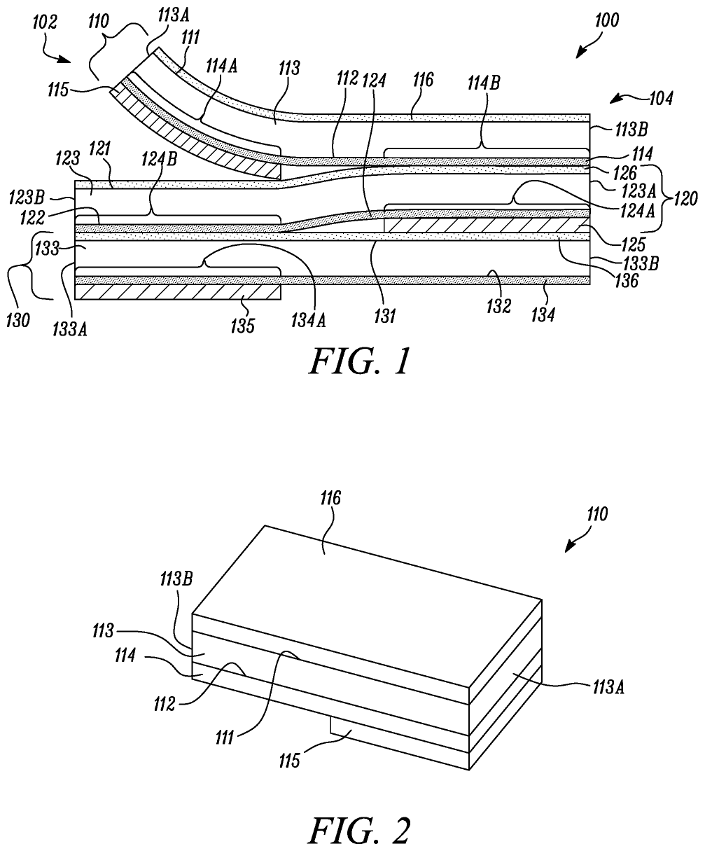

FIG. 1 illustrates a side sectional view of one embodiment of a tape strip stack 100 (hereinafter referred to as “stack 100”). The stack 100 includes a first end 102 and a second end 104, opposite the first end 102. The stack 100 further includes a first tape strip 110, a second tape strip 120, and a third tape strip 130 stacked on top of each other. Three sequentially stacked tape strips 110, 120, 130 are shown in FIG. 1 for the purposes of clarity. However, the stack 100 may include any number of tape strips within the scope of the present disclosure.

The first tape strip 110 includes a substrate 113 having a first major surface 111 and a second major surface 112, opposite the first major surface 111. The first tape strip 110 further includes a low adhesion backsize 116 at the first major surface 111 of the substrate 113 of the first tape strip 110. The first tape strip 110 further includes an adhesive 114 disposed on an entirety of the second major surface 112 of the substrate 113 of the first tape strip 110. The first tape strip 110 further includes a tab 115 secured to a portion 114A of the adhesive 114 disposed on the substrate 113 of the first tape strip 110 at the first end 102 of the stack 100.

The second tape strip 120 includes a substrate 123 having a first major surface 121 and a second major surface 122, opposite the first major surface 121. The second tape strip 120 further includes a low adhesion backsize 126 at the first major surface 121 of the substrate 123 of the second tape strip 120. The second tape strip 120 further includes an adhesive 124 disposed on an entirety of the second major surface 122 of the substrate 123 of the second tape strip 120. The second tape strip 120 further includes a tab 125 secured to a portion 124A of the adhesive 124 disposed on the substrate 123 of the second tape strip 120 at the second end 104 of the stack 100. The adhesive 114 of the first tape strip 110 removably secures to the low adhesion backsize 126 on the first major surface 121 of the substrate 123 of the second tape strip 120 at the second end 104 of the stack 100.

The third tape strip 130 includes a substrate 133 having a first major surface 131 and a second major surface 132, opposite the first major surface 131. The third tape strip 130 further includes a low adhesion backsize 136 at the first major surface 131 of the substrate 133 of the third tape strip 130. The third tape strip 130 further includes an adhesive 134 disposed on an entirety of the second major surface 132 of the substrate 133 of the third tape strip 130. The third tape strip 130 further includes a tab 135 secured to a portion 134A of the adhesive 134 disposed on the substrate 133 of the third tape strip 130 at the first end 102 of the stack 100. The adhesive 124 of the second tape strip 120 removably secures to the low adhesion backsize 136 on the first major surface 131 of the substrate 133 of the third tape strip 130 at the first end 102 of the stack 100.

In some embodiments, the adhesive 114, 124, 134 of each of the first, second and third tape strips 110, 120, 130 is a pressure sensitive adhesive.

The substrate 113 of the first tape strip 110 includes a first edge 113A proximate the first end 102 of the stack 100 and a second edge 113B, opposite the first edge 113A. The first and second edges 113A, 113B may be transverse edges of the substrate 113. The tab 115 is attached to the portion 114A of the adhesive 114 that extends from the first edge 113A of the substrate 113. The tab 115 at least partially covers the adhesive 114. In some embodiments, the tab 115 covers at least 10%, at least 20%, at least 30%, at least 40%, or at least 50% of an entire surface area of the adhesive 114. In other words, the portion 114A of the adhesive 114 secured to the tab 115 may be at least 10%, at least 20%, at least 30%, at least 40%, or at least 50% of the entire surface area of the adhesive 114.

A portion 114B of the adhesive 114 extending from the second edge 113B of the substrate 113 and not secured to the tab 115 of the first tape strip 110 is removably secured to the low adhesion backsize 116 on the first major surface 121 of the substrate 123 of the second tape strip 120. The portion 114A of the adhesive 114 that is secured to the tab 115 and the portion 114B of the adhesive 114 that is removably secured to the low adhesion backsize 116 may have same or different areas. In some embodiments, the portion 114B of the adhesive 114 is at least 10%, at least 20%, at least 30%, at least 40%, or at least 50% of the entire surface area of the adhesive 114. In some cases, a portion of the adhesive 114 may remain unsecured to both the tab 115 and the low adhesion backsize 116.

The substrate 123 of the second tape strip 120 includes a first edge 123A proximate the second end 104 of the stack 100 and a second edge 123B, opposite the first edge 123A. The first and second edges 123A, 123B may be transverse edges of the substrate 123. The tab 125 is attached to the portion 124A of the adhesive 124 that extends from the first edge 123A of the substrate 123. The tab 125 at least partially covers the adhesive 124. In some embodiments, the tab 125 covers at least 10%, at least 20%, at least 30%, at least 40%, or at least 50% of an entire surface area of the adhesive 124. In other words, the portion 124A of the adhesive 124 secured to the tab 125 may be at least 10%, at least 20%, at least 30%, at least 40%, or at least 50% of the entire surface area of the adhesive 124.

A portion 124B of the adhesive 124 extending from the second edge 123B of the substrate 123 and not secured to the tab 125 of the second tape strip 120 is removably secured to the low adhesion backsize 136 on the first major surface 131 of the substrate 133 of the third tape strip 130. The portion 124A of the adhesive 124 that is secured to the tab 125 and the portion 124B of the adhesive 124 that is removably secured to the low adhesion backsize 136 may have same or different areas. In some embodiments, the portion 124B of the adhesive 124 is at least 10%, at least 20%, at least 30%, at least 40%, or at least 50% of the entire surface area of the adhesive 124. In some cases, a portion of the adhesive 124 may remain unsecured to both the tab 125 and the low adhesion backsize 136.

The substrate 133 of the third tape strip 130 includes a first edge 133A proximate the first end 102 of the stack 100 and a second edge 123B, opposite the first edge 123A. The first and second edges 133A, 133B may be transverse edges of the substrate 133. The tab 135 is attached to the portion 134A of the adhesive 134 that extends from the first edge 133A of the substrate 133. The tab 135 at least partially covers the adhesive 134. In some embodiments, the tab 135 covers at least 10%, at least 20%, at least 30%, at least 40%, or at least 50% of an entire surface area of the adhesive 134. In other words, the portion 134A of the adhesive 134 secured to the tab 135 may be at least 10%, at least 20%, at least 30%, at least 40%, or at least 50% of the entire surface area of the adhesive 134.

A portion (not shown) of the adhesive 134 extending from the second edge 133B of the substrate 133 and not secured to the tab 135 of the third tape strip 130 is removably secured to the low adhesion backsize on the first major surface of an underlying substrate (not shown). The portion 134A of the adhesive 134 that is secured to the tab 135 and the portion of the adhesive 134 that is removably secured to the low adhesion backsize may have same or different areas. In some embodiments, the portion of the adhesive 134 that is secured to the low adhesion backsize of the underlying substrate is at least 10%, at least 20%, at least 30%, at least 40%, or at least 50% of the entire surface area of the adhesive 134. In some cases, a portion of the adhesive 124 may remain unsecured to both the tab 125 and the low adhesion backsize of the underlying substrate.

In some embodiments, each of the substrates 113, 123, 133 along with the corresponding adhesives 114, 124, 134 is a precut adhesive tape strip. The precut adhesive tape strip may be used for medical applications, for example, as a medical tape or dressing.

In some embodiments, the tab 115, 125, 135 of each of the first, second and third tape strips 110, 120, 130 is a removable release tab removably secured to the corresponding adhesive 114, 124, 134. Each of the tabs 115, 125, 135 may act as a releasable liner for the corresponding adhesive 114, 124, 134. In some other embodiments, the tab 115, 125, 135 of each of the first, second and third tape strips 110, 120, 130 is fixedly secured to the corresponding substrate 113, 123, 133. For example, the tab 115, 125, 135 of each of the first, second and third tape strips 110, 120, 130 may be laminated to the corresponding substrate 113, 123, 133 via the corresponding adhesive 114, 124, 134.

In some embodiments, the tab 115, 125, 135 of each of the first, second and third tape strips 110, 120, 130 is not secured to the first major surface of an underlying substrate. Specifically, the tab 115 of the first tape strip 110 is not secured to the first major surface 121 of the substrate 123 of the second tape strip 120. Further, the tab 125 of the second tape strip 120 is not secured to the first major surface 131 of the substrate 133 of the third tape strip 130. The tab 135 of the third tape strip 130 is not secured to the first major surface of the underlying substrate (not shown).

In some embodiments, the adhesive 114, 124, 134 of each of the first, second and third tape strips 110, 120, 130 is fully coated on the entirety of the second major surface 112, 122, 132 of the corresponding substrate 113, 123, 133. Each of the adhesives 114, 124, 134 is continuous and covers an entire surface area of the corresponding second major surface 112, 122, 132. In some other embodiments, the adhesive 114, 124, 134 of each of the first, second and third tape strips 110, 120, 130 is pattern coated on the entirety of the second major surface 112, 122, 132 of the corresponding substrate 113, 123, 133. Each of the adhesives 114, 124, 134 is discontinuous and covers less than the entire surface area of the corresponding second major surface 112, 122, 132. Pattern coating may include dots, laterally spaced parallel lines, crosshatching, etc.

In some embodiments, the low adhesion backsize 116, 126, 136 of the first, second and third tape strips 110, 120, 130 is disposed on an entirety of the first major surface 111, 121, 131 of the corresponding substrate 113, 123, 133. Each of the low adhesion backsizes 116, 126, 136 is continuous and covers an entire surface area of the corresponding first major surface 111, 121, 131. In some other embodiments, each of the low adhesion backsizes 116, 126, 136 is non-uniformly disposed on the first major surface 111, 121, 131 of the corresponding substrate 113, 123, 133. For example, the low adhesion backsize 116, 126, 136 of each of the first, second and third tape strips 110, 120, 130 may be pattern coated on the entirety of the first major surface 111, 121, 131 of the corresponding substrate 113, 123, 133. Each of the low adhesion backsizes 116, 126, 136 may be discontinuous and may cover less than the entire surface area of the corresponding first major surface 111, 121, 131. Pattern coating may include dots, laterally spaced parallel lines, crosshatching, etc.

The adhesive 114 removably secures the substrate 113 of the first tape strip 110 to the substrate 123 of the second tape strip 120 at the second end 104 of the stack 100. The tab 115 of the first tape strip 110 is disposed at the first end 102 of the stack 100. The adhesive 124 removably secures the substrate 123 of the second tape strip 120 to the substrate 133 of the third tape strip 130 at the first end 102 of the stack 100. The tab 125 of the second tape strip 120 is disposed at the second end 104 of the stack 100. The adhesive 134 removably secures the substrate 133 of the third tape strip 130 to the underlying substrate at the second end 104 of the stack 100. The tab 135 of the third tape strip 130 is disposed at the first end 102 of the stack 100. In general, successive substrates are connected to each other at alternating ends of the stack 100. Further, the tabs are disposed at alternating ends of the stack 100 between successive substrates. The stack 100 may therefore be a Z-stack of tape strips. A Z-folded or fan-folded configuration of the stack 100 may facilitate dispensing of successive tape strips from a dispenser (not shown in FIG. 1) in a pop-up manner.

In some embodiments, the stack 100 is received within the dispenser. The dispenser includes an opening for dispensing of the first, second and third tape strips 110, 120, 130. A portion of the substrate 113 of the first tape strip 110 extends at least partly through the opening of the dispenser. The portion of the substrate 113 protruding through the opening is fully covered by the tab 115. Therefore, the tab 115 fully covers the adhesive 114 disposed on the portion of the substrate 113 protruding through the opening. In general, a portion of the substrate protruding through the opening is fully covered by the corresponding tab. This may protect the adhesive disposed on the portion of the substrate from contamination.

The first tape strip 110 can be dispensed by one hand by pulling the tab 115 and the substrate 113 extending through the opening of the dispenser without contaminating the adhesive 114. Upon pulling the substrate 113 of the first tape strip 110, the second tape strip 120 at least partly extends from the opening due to the removable connection between the substrate 113 of the first tape strip 110 and the substrate 123 of the second tape strip 120. The second tape strip 120 can extend at least partly through the opening upon pulling of the substrate 113 due to the fan-folded configuration of the stack 100. Specifically, the removable adhesive connection between the second tape strip 120 and the third tape strip 130 is at an opposite end relative to the removable adhesive connection between the first tape strip 110 and the second tape strip 120. Therefore, the second tape strip 120 can move along with the first tape strip 110 without substantially impacting the removable adhesive connection with the third tape strip 130.

The substrate 113 of the first tape strip 110 can be then detached from the substrate 123 of the second tape strip 120 by further pulling. The substrate 123 of the second tape strip 120 may then extend at least partly through the opening of the dispenser. The tab 125 completely covers the adhesive 124 disposed on the portion of the substrate 123 protruding through the opening of the dispenser. The second tape strip 120 can be dispensed by one hand in a similar manner as the first tape strip 110. In general, a substrate of an uppermost tape strip of the stack 100 extends at least partly through the opening of the dispenser. The adhesive on the protruding or exposed portion of the substrate of the uppermost tape strip is fully covered by the corresponding tab. The tab may therefore act as a liner for the adhesive. The adhesive may therefore be protected from contaminants. Upon pulling the substrate and tape of the uppermost tape strip by one hand, the substrate of the underlying tape strip also extends at least partially through the opening. The substrate of the uppermost tape strip can be detached from the substrate of the underlying tape strip by further pulling.

In general, the low adhesion backsize on the first major surface of a substrate may facilitate separation of an overlying tape strip. For example, the low adhesion backsize 126 of the second tape strip 120 may allow for separation of the substrate 113 of the first tape strip 110 from the substrate 123. Similarly, the low adhesion backsize 136 of the third tape strip 130 may allow for separation of the substrate 123 of the second tape strip 120 from the substrate 133.

FIG. 2 illustrates a perspective view of the first tape strip 110. In the illustrated embodiment of FIG. 2, each of the substrate 113 and the tab 115 is substantially rectangular. Further, a width of the tab 115 is substantially equal to a width of the substrate 113. However, each of the substrate 113 and the tab 115 may have alternative shapes, such as circular, square, polygonal, elliptical, oval, and so forth. In some embodiments, a length of the tab 115 may be at least 10%, at least 20%, at least 30%, at least 40%, or at least 50% of a length of the substrate 113. In some embodiments, a thickness of the tab 115 may be less than a thickness of the substrate 113. In some other embodiments, the thickness of the tab 115 may be greater than or equal to the thickness of the substrate 113. In some embodiments, a thickness of the adhesive 114 may be greater than a thickness of the low adhesion backsize 116. In some other embodiments, the thickness of the adhesive 114 may be less than or equal to the thickness of the low adhesion backsize 116. Further, the thickness of the adhesive 114 may less than the thickness of each of the tab 115 and the substrate 113.

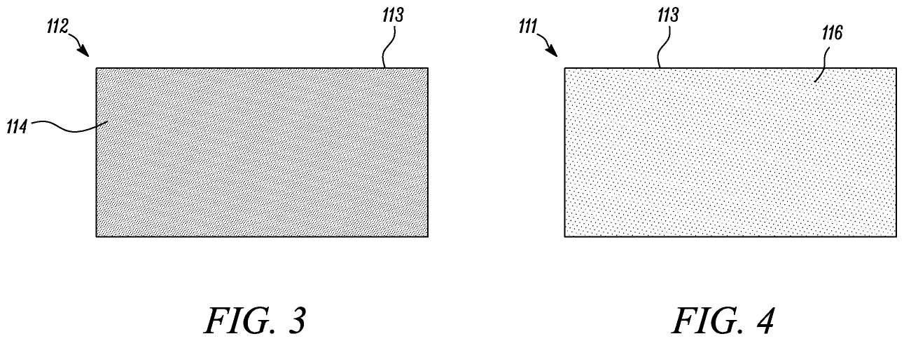

FIG. 3 illustrates a bottom view of the first tape strip 110 without the tab 115. As shown in FIG. 3, the adhesive 114 covers the entire surface area of the second major surface 112 of the substrate 113 in a continuous manner. However, in alternative embodiments, the adhesive 114 may be disposed on the entirety of the second major surface 112 of the substrate 113 in a discontinuous manner. For example, the adhesive 114 may be arranged in a pattern on the second major surface 112 of the substrate 113. The pattern may include dots, laterally spaced parallel lines, crosshatching, etc.

FIG. 4 illustrates a top view of the first tape strip 110. As shown in FIG. 4, the low adhesion backsize 116 covers the entire surface area of the first major surface 111 of the substrate 113 in a continuous manner. However, in alternative embodiments, the low adhesion backsize 116 may be disposed on the entirety of the first major surface 111 of the substrate 113 in a discontinuous manner. For example, the low adhesion backsize 116 may be arranged in a pattern on the first major surface 111 of the substrate 113. The pattern may include dots, laterally spaced parallel lines, crosshatching, etc.

The first tape strip 110 is shown in FIGS. 2, 3 and 4 for illustration purposes. It may be contemplated that each of the second and third tape strips 120, 130 may have a configuration that is substantially similar to that of the first tape strip 110.

Individual components of each of the first, second and third tape strips 110, 120, 130 may include different materials/configurations. Some exemplary materials/configurations are provided below.

Substrate

Each of the substrates 113, 123, 133 may include substantially any flat, flexible material having the necessary structural integrity. Suitable materials include (i) polymeric films of brightened acetate, unbrightened acetate, thermosets, thermoplastics such as polyester, polypropylene, and vinyl polymers, (ii) paper, and (iii) metal foil. Various laminated combinations of such materials may also be used. In some embodiments, each of the substrates 113, 123, 133 is made of biaxially oriented polypropylene (BOPP). In some embodiments, each of the substrates 113, 123, 133 is a perforated tape.

Adhesive

Each of the adhesives 114, 124, 134 may be any of a variety of removable/repositionable adhesives, preferably, of pressure sensitive type. Any of the known pressure sensitive adhesives, including, but not limiting to, acrylic, silicone, silicone-acrylate hybrid, silicone block co-polymers, rubber-resin pressure sensitive adhesives, natural rubber, and low peel pressure sensitive adhesives containing tacky elastomeric copolymer microspheres may be used. In some applications, the adhesive can be suitable for securing to skin. The adhesives can be a continuous coating, a pattern coating, or microstructured.

Low Adhesion Backsize

Each of the low adhesion backsizes 116, 126, 136 may be coated on the first major surface 111, 121, 131 of the respective substrate 113, 123, 133. Low adhesion backsize refers to a material capable of readily releasing from a layer of a pressure sensitive adhesive. A number of materials suitable for use as a low adhesion backsize are known to those skilled in the art, including specifically, but not exclusively silicones, fluorocarbons, acrylates, urethanes, chrome complexes, grafted and block siloxane hydrocarbons, and blends of these materials. These release materials could be a continuous coating, pattern coating, or microstructured materials.

Tabs

Each of the tabs 115, 125, 135 may include substantially any flat, flexible material having the necessary structural integrity. Suitable materials include (i) polymeric films of brightened acetate, unbrightened acetate, thermosets, thermoplastics such as polyester, polypropylene, and vinyl polymers, (ii) paper, and (iii) metal foil. Various laminated combinations of such materials may also be used. Suitable materials may further include silicone coated paper, silicone coated polyethylene terephthalate (PET), etc.

In an exemplary manufacturing process, an elongate portion of an adhesive tape (substrate and adhesive) may be cut from a sheet. Further, an elongate portion of a tab may be cut from a sheet. The elongate portion of the adhesive tape may have a rectangular shape. Similarly, the elongate portion of the tab may have a rectangular shape. An elongate tape strip may be formed by removably securing the elongate portion of the tab to the elongate portion of the adhesive tape such that a section of the adhesive is uncovered by the tab. This process may be repeated multiple times to form multiple elongate tape strips. The elongate tape strips may be stacked in an alternating manner such that successive tabs are located at alternate ends of the stack. The stack may be then cut into a desired stack width by a pair of fixed blades. Any residual portion of the stack may be removed. Multiple fan folded stacks of tape strips may be formed. One such stack may be placed within a dispenser to form a dispensing system. A portion of the tape strip covered with the tab may protrude from an opening of the dispenser. This portion may act as a flag for one-handed dispensing of the tape strip. The tab can be removed to expose a whole adhesive surface of the tape strip. In some cases, the tab may not be removable. In such cases, the tab may be laminated to the adhesive tape.

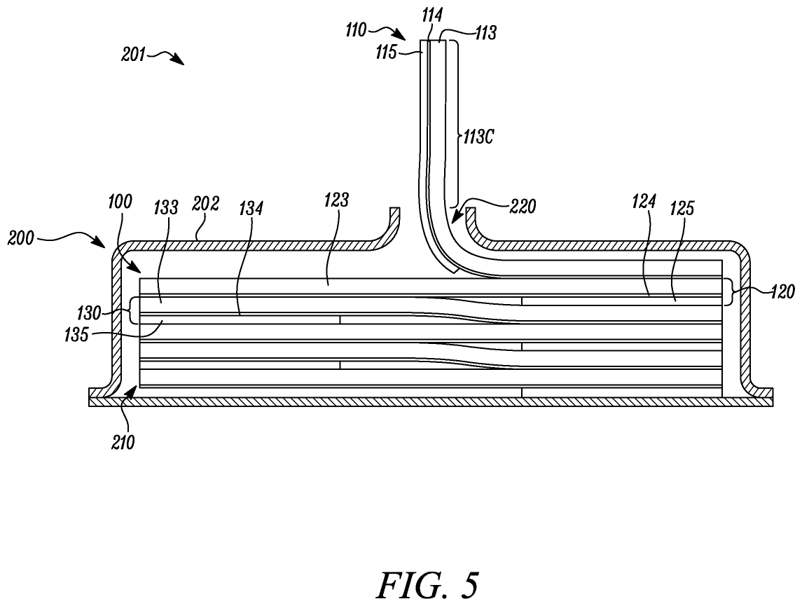

FIG. 5 illustrates a dispensing system 201 including a dispenser 200 and the stack 100 received within the dispenser 200. For the purposes of clarity, only the first, second and third tape strips 110, 120, 130 are referenced by numerals in FIG. 5. Further, the low adhesion backsizes 116, 126, 136 are not shown in FIG. 5. The underlying tape strips, through shown, are not referenced separately. The dispenser 200 may enable pop-up dispensing of the first, second and third tape strips 110, 120, 130 of the stack 100.

The dispenser 200 includes a housing 202 defining a cavity 210 and an opening 220. The opening 220 is disposed at a top portion of the housing 202. The housing 202 may be made of a variety of materials including, but not limited to, plastic, paper, glass, metal, or a combination thereof. The opening 220 may be a slot. The stack 100 is received within the cavity 210 of the housing 202. The substrate 113 of the first tape strip 110 protrudes at least partly through the opening 220 of the dispenser 200. Specifically, a portion 113C of the substrate 113 of the first tape strip 110 protrudes through the opening 220 of the dispenser 200. The tab 115 of the first tape strip 110 also extends at least partly through the opening 220. The portion 113C of the substrate 113 of the first tape strip 110 protruding through the opening 220 is fully covered by the tab 115. Further, the adhesive 114 disposed on the portion 113C of the substrate 113 is fully covered by the tab 115. The portion 113C of the substrate 113 along with the tab 115 may form a flag for one-handed dispensing of the first tape strip 110. The adhesive 114 of the flag may be protected from contaminants by the tab 115.

A design of the dispenser 200 can be modified based on various parameters of the stack 100, such as shape, dimensions, material etc. The dispenser 200 can be mounted on a surface or a component. In some cases, the dispenser 200 can be a wearable device that can be carried by a person. The dispenser 200 can be used in various environments in the vicinity of a patient or a clinician. The dispenser 200 can be mounted or positioned in different areas, for example, cabinets, walls, tables, bed rail, attending caregivers, clinicians, and so forth. In some embodiments, the dispenser 200 is disposable.

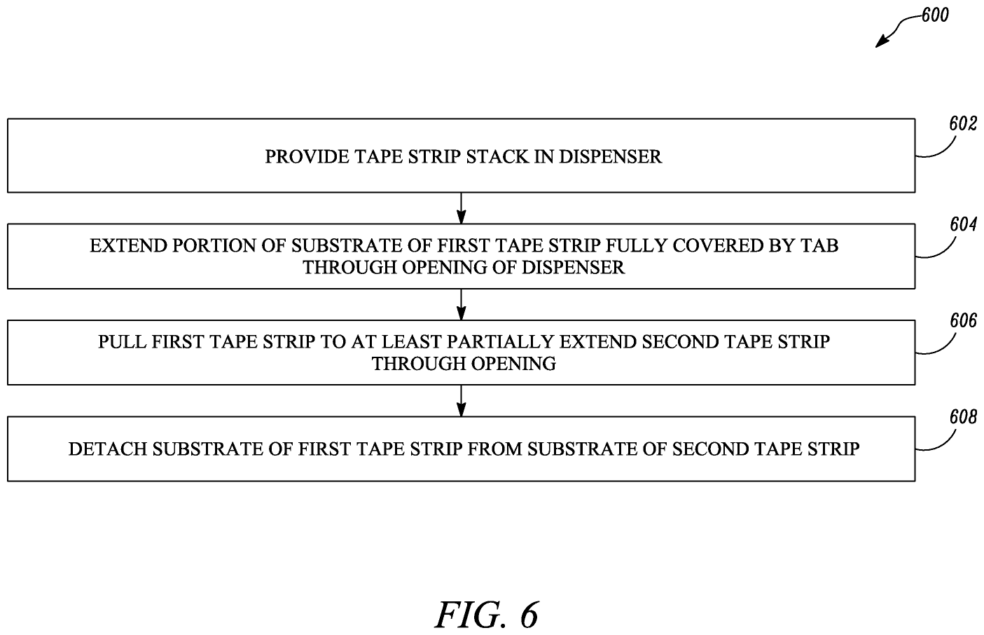

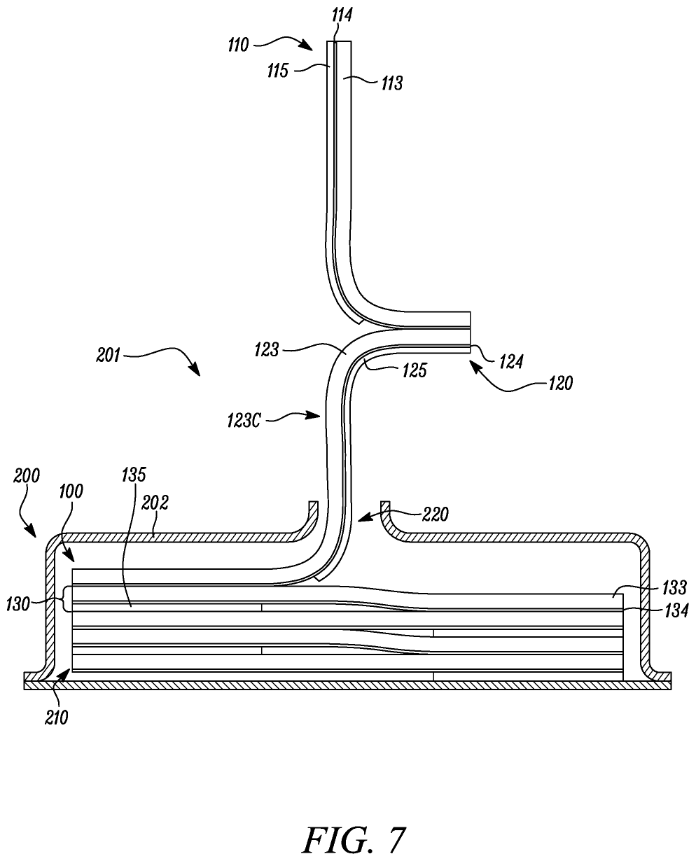

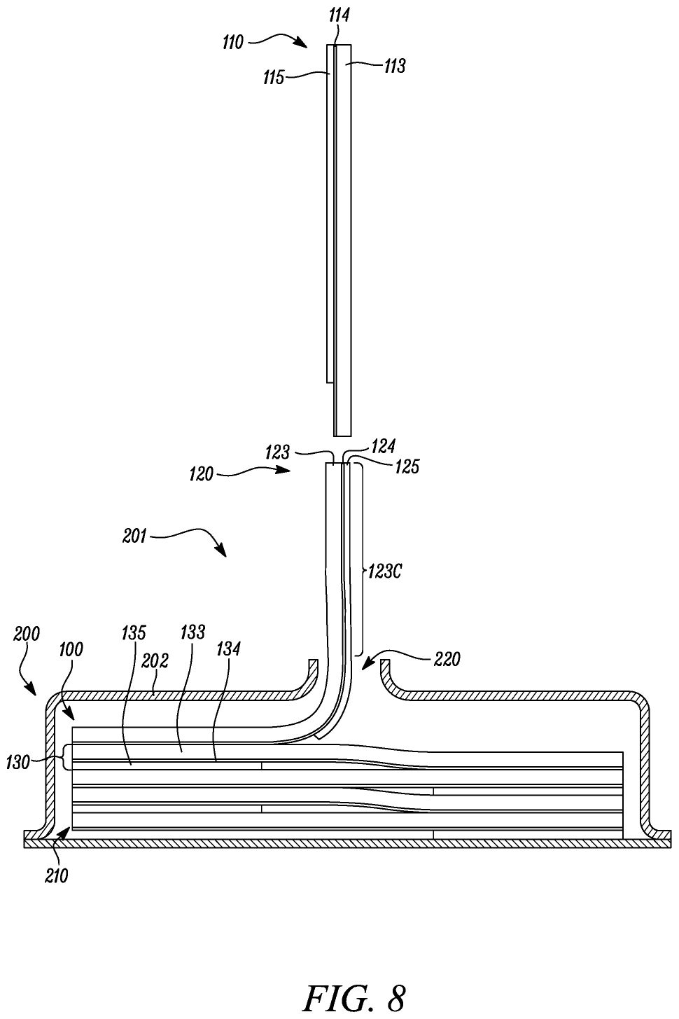

FIG. 6 illustrates a flowchart of a method 600 of dispensing the stack 100 of the dispensing system 201. FIGS. 7 and 8 illustrate dispensing of the first tape strip 110 from the dispenser 200. Referring to FIGS. 5 to 8, at step 602, the method 600 includes providing the stack 100 in the dispenser 200. The stack 100 is disposed within the cavity 210 of the housing 202.

At step 604, the method 600 includes extending the portion 113C of the substrate 113 of the first tape strip 110 fully covered by the tab 115 through the opening 220 of the dispenser 200. The tab 115 also fully covers the adhesive 114 disposed on the portion 113C of the substrate 113.

At step 606, the method 600 further includes pulling the first tape strip 110 to at least partially extend the second tape strip 120 through the opening 220. The flag formed by the portion 113C and the tab 115 may be used to pull the first tape strip 110 away from the dispenser 200 by a single hand. As shown in FIG. 7, upon pulling the first tape strip 110, the substrate 123 of the second tape strip 120 also extends at least partially through the opening 220. This is due to the removable adhesive connection between the substrate 113 of the first tape strip 110 and the substrate 123 of the second tape strip 120.

At step 608, the method 600 further includes detaching the substrate 113 of the first tape strip 110 from the substrate 123 of the second tape strip 120. As shown in FIG. 8, upon further pulling of the first tape strip 110, the substrate 113 of the first tape strip 110 detaches from the substrate 123 of the second tape strip 120 by a peeling action. Due to the Z-folded configuration of the stack 100, the removable adhesive connection between the substrate 123 of the second tape strip 120 and the substrate 133 of the third tape strip 130 may remain substantially intact during dispensing of the first tape strip 110. Upon removal of the first tape strip 110, the substrate 123 of the second tape strip 120 extends at least partly through the opening 220 to enable one-handed dispensing. A portion 123C of the substrate 123 of the second tape strip 120 protruding through the opening 220 is fully covered by the tab 125 of the second tape strip 120. Further, the adhesive 124 disposed on the portion 123C of the substrate 123 is fully covered by the tab 125.

In general, the uppermost tape strip of the stack 100 can be removed by pulling the corresponding substrate and tab. Upon removal of the uppermost tape strip, the underlying tape strip pops up and extends through the opening 220 of the dispenser 200. Successive tape strips can be sequentially dispensed in a similar manner.

The stack 100 and the dispensing system 201 of the present disclosure may enable one-handed dispensing. The stack 100 may further enable compact and flat packaging as opposed to conventional tape rolls. Compact packaging may facilitate shipping and supply. The stack 100 and the dispensing system 201 can easily fit into kits. Further, the dispensing system 201 can be easily placed at a point of use or care. The stack 100 may also allow the tape strips to be organized efficiently. An adhesive on an exposed portion of a tape strip may be fully covered by a tab, and therefore protected from contaminants. In some cases, the tab can be removed to expose a whole adhesive surface. The adhesive may therefore be available for use.

Although specific embodiments have been shown and described herein, it is understood that these embodiments are merely illustrative of the many possible specific arrangements that can be devised in application of the principles of the invention. Numerous and varied other arrangements can be devised in accordance with these principles by those of skill in the art without departing from the spirit and scope of the invention. The scope of the present invention should not be limited to the structures described in this application, but only by the structures described by the language of the claims and the equivalents of those structures.

What is claimed is:

1. A tape strip stack with a first end and a second end, opposite the first end, the tape strip stack comprising:
a first tape strip comprising:
a substrate having a first major surface and a second major surface, opposite the first major surface;
a low adhesion backsize at the first major surface of the substrate of the first tape strip;
an adhesive disposed on an entirety of the second major surface of the substrate of the first tape strip; and
a tab secured to a portion of the adhesive disposed on the substrate of the first tape strip at the first end of the stack; and
a second tape strip comprising:
a substrate having a first major surface and a second major surface, opposite the first major surface;
a low adhesion backsize at the first major surface of the substrate of the second tape strip;
an adhesive disposed on an entirety of the second major surface of the substrate of the second tape strip; and
a tab secured to a portion of the adhesive disposed on the substrate of the second tape strip at the second end of the stack;
wherein the adhesive of the first tape strip removably secures to the low adhesion backsize on the first major surface of the substrate of the second tape strip at the second end of the stack.

2. The tape strip stack according to claim 1, further comprising:
a third tape strip comprising:
a substrate having a first major surface and a second major surface, opposite the first major surface;
a low adhesion backsize at the first major surface of the substrate of the third tape strip;
an adhesive disposed on an entirety of the second major surface of the substrate of the third tape strip; and
a tab secured to a portion of the adhesive disposed on the substrate of the third tape strip at the first end of the stack;
wherein the adhesive of the second tape strip removably secures to the low adhesion backsize on the first major surface of the substrate of the third tape strip at the first end of the stack.

3. The tape strip stack according to claim 2, wherein the tab of each of the first, second and third tape strips is a removable release tab removably secured to the corresponding adhesive.

4. The tape strip stack according to claim 2, wherein the tab of each of the first, second and third tape strips is fixedly secured to the corresponding substrate.

5. The tape strip stack according to claim 2, wherein the tab of each the first, second and third tape strips is not secured to the first major surface of an underlying substrate.

6. The tape strip stack according to claim 2, wherein the adhesive of each of the first, second and third tape strips is fully coated on the entirety of the second major surface of the corresponding substrate.

7. The tape strip stack according to claim 2, wherein the adhesive of each of the first, second and third tape strips is pattern coated on the entirety of the second major surface of the corresponding substrate.

8. The tape strip stack according to claim 2, wherein the low adhesion backsize of each of the first, second and third tape strips is disposed on an entirety of the first major surface of the corresponding substrate.

9. The tape strip stack according to claim 2, wherein the adhesive of each of the first, second and third tape strips is a pressure sensitive adhesive.

10. A dispenser comprising an opening, the dispenser receiving the tape strip stack according to claim 1, wherein a portion of the substrate protruding through the opening is fully covered by the corresponding tab.

11. A dispensing system comprising:
a dispenser comprising an opening; and
a tape strip stack with a first end and a second end, opposite the first end, the tape strip stack received within the dispenser, the tape strip stack comprising:
a first tape strip comprising:
a substrate having a first major surface and a second major surface, opposite the first major surface, wherein a portion of the substrate of the first tape strip protrudes through the opening of the dispenser;
a low adhesion backsize at the first major surface of the substrate of the first tape strip;
an adhesive disposed on an entirety of the second major surface of the substrate of the first tape strip; and
a tab secured to a portion of the adhesive disposed on the substrate of the first tape strip at the first end of the stack; and
a second tape strip comprising:
a substrate having a first major surface and a second major surface, opposite the first major surface;
a low adhesion backsize at the first major surface of the substrate of the second tape strip;
an adhesive disposed on an entirety of the second major surface of the substrate of the second tape strip; and
a tab secured to a portion of the adhesive disposed on the substrate of the second tape strip at the second end of the stack;
wherein the adhesive of the first tape strip removably secures to the low adhesion backsize on the first major surface of the substrate of the second tape strip at the second end of the stack, and wherein the portion of the substrate of the first tape strip protruding through the opening is fully covered by the tab of the first tape strip.

12. The dispensing system according to claim 11, wherein the tape strip stack further comprises:
a third tape strip comprising:
a substrate having a first major surface and a second major surface, opposite the first major surface;
a low adhesion backsize at the first major surface of the substrate of the third tape strip;
an adhesive disposed on an entirety of the second major surface of the substrate of the third tape strip; and
a tab secured to a portion of the adhesive disposed on the substrate of the third tape strip at the first end of the stack;
wherein the adhesive of the second tape strip removably secures to the low adhesion backsize on the first major surface of the substrate of the third tape strip at the first end of the stack.

13. The dispensing system according to claim 12, wherein the tab of each of the first, second and third tape strips is a removable release tab removably secured to the corresponding adhesive.

14. The dispensing system according to claim 12, wherein the tab of each of the first, second and third tape strips is fixedly secured to the corresponding substrate.

15. The dispensing system according to claim 12, wherein the tab of each the first, second and third tape strips is not secured to the first major surface of an underlying substrate.

16. The dispensing system according to claim 12, wherein the adhesive of each of the first, second and third tape strips is fully coated on the entirety of the second major surface of the corresponding substrate.

17. The dispensing system according to claim 12, wherein the adhesive of each of the first, second and third tape strips is pattern coated on the entirety of the second major surface of the corresponding substrate.

18. The dispensing system according to claim 12, wherein the low adhesion backsize of each of the first, second and third tape strips is disposed on an entirety of the first major surface of the corresponding substrate.

19. The dispensing system according to claim 12, wherein the adhesive of each of the first, second and third tape strips is a pressure sensitive adhesive.

20. A method of dispensing the tape strip stack of the dispensing system according to claim 11, the method comprising:
providing the tape strip stack in the dispenser;
extending the portion of the substrate of the first tape strip fully covered by the tab through the opening of the dispenser;
pulling the first tape strip to at least partially extend the second tape strip through the opening; and
detaching the substrate of the first tape strip from the substrate of the second tape strip.
